(19) United States
(12) Patent Application Publication
(10) Pub. No.: US 2007/0258323 A1
(43) Pub. Date: Nov. 8, 2007

(54) Method for Seismic Trace Decomposition and Reconstruction Using Multiple Wavelets

(76) Inventor: Ping An, Katy, TX (US)

Correspondence Address: Ping An, 2019 Edendale Circle, KATY, TX, 77450, US

(21) Appl. No.: 11/382,042

(22) Filed: May 7, 2006

(51) Int. Cl. G01V 1/00

(52) U.S. Cl. 367/38

(57) ABSTRACT

The present invention has established a method for decomposing a seismic trace, which can be a pre-stack or post-stack seismic trace, into a set of seismic wavelets of different shapes and for reconstructing a new seismic trace by a subset of the wavelets and the original seismic trace by all the wavelets in the set of the wavelets. The seismic trace can be decomposed into a set of pre-defined seismic wavelets of different shapes. The wavelets from the decomposition are saved to a computer device such as a hard disk drive. A new seismic trace is reconstructed by a selected subset of the set of wavelets. The original seismic trace is reconstructed accurately with all the wavelets in the set of wavelets. For a 2D seismic section or a 3D seismic volume, the decomposition of the section or volume will generate a computer file of sets of the wavelets. Each set of wavelets in the file corresponds to a seismic data trace. New seismic sections or volumes can be generated by reconstruction of the seismic traces with certain subsets of the seismic wavelets.

### FIELD OF THE INVENTION

The present invention relates generally to the field of seismic data processing and interpretation. More specifically, the invention relates to decompose a prestack or poststack seismic trace into a set of predefined wavelets of different shapes and reconstruct a new seismic trace using a subset of the wavelets or the original seismic trace with all the wavelets.

### BACKGROUND OF THE INVENTION

In seismic prospecting, a seismic source is used to generate a seismic wave that propagates into the earth and is at least partially reflected by subsurface seismic reflectors. The reflected signals are recorded by seismic receivers located at or near the surface of the earth, in an overlying body of water, or at known depths in boreholes, and the resulting seismic data are seismic data traces and may be processed to yield information relating to the subsurface formations.

Seismic prospecting consists of three separate stages: data acquisition, data processing, and data interpretation. The seismic energy recorded by each seismic receiver is known as a “seismic data trace”. Seismic data traces typically contain both the desired seismic reflections and one or more unwanted noise components that can overwhelm the wanted seismic reflections.

One method for attenuating unwanted noise components in seismic data traces is through the common-midpoint (CMP) stacking process. the “midpoint” for a seismic data trace is the point midway between the source location and the receiver location for that trace. According to the CMP method, the recorded seismic data traces are sorted into common-midpoint gathers each of which contains a number of different seismic data traces of the same midpoint but different source-to-receiver offset distances. The seismic data traces within each CMP gather are corrected for statics and normal moveout and are then summed or “stacked” to yield a stacked data trace which is a composite of the individual seismic data traces in the CMP gather. Before the summing process, the individual seismic data traces are normally called pre-stack seismic traces. After the summing process, the summed or stacked data traces are normally called post-stack seismic traces. Typically, the post-stack data trace has a significantly improved signal-to-noise ratio compared to that of the pre-stack seismic data traces.

In seismic prospecting, it is well known that the conventionally and commonly used model for a seismic trace is the mathematical convolutional model (Sheriff, 1999), which is defined as the convolution of a single source wavelet with a seismic reflection coefficient function:
x(t)=w(t)*r(t)+n(t),

where x(t) is the recorded seismic trace, w(t) is the seismic source wavelet, r(t) is the earth's reflectivity function, n(t) is random noise, and “*” represents mathematical convolution. This model is used and implied in seismic data processing and interpretation, such as deconvolution and inversion.

One of the assumptions of the convolutional model is the single Wavelet assumption, which assumes that the source wavelet remain invariant as it travels through the subsurface. This single wavelet model is, however, far from the real situation. It is an obvious fact that the frequency of a seismic trace becomes lower when depth increases.

The seismic response of a subsurface layer with different physical properties is different. The shapes of a seismic wavelet will change when the wavelet passes through the layer. The changes will be different at different locations where the physical properties of the layer are different. The difference in wavelet shape changes is valuable information to predict the changes in formation and petrophysical properties.

Without implying the single wavelet assumption, the current invention establishes a method for decomposing seismic traces into multiple wavelets of different shapes. This approach is obviously more realistic and provides more capabilities in seismic data processing and interpretation.

### SUMMARY OF THE INVENTION

The present invention has established a method for decomposing a seismic trace that can be a prestack or poststack seismic trace, into a set of predefined seismic wavelets of different shapes and reconstructing the original seismic trace with the set of wavelets and a new seismic trace with a selected subset of the set of wavelets. This invention can be divided into two parts: decomposition of a seismic trace and reconstruction of a new or original seismic trace.

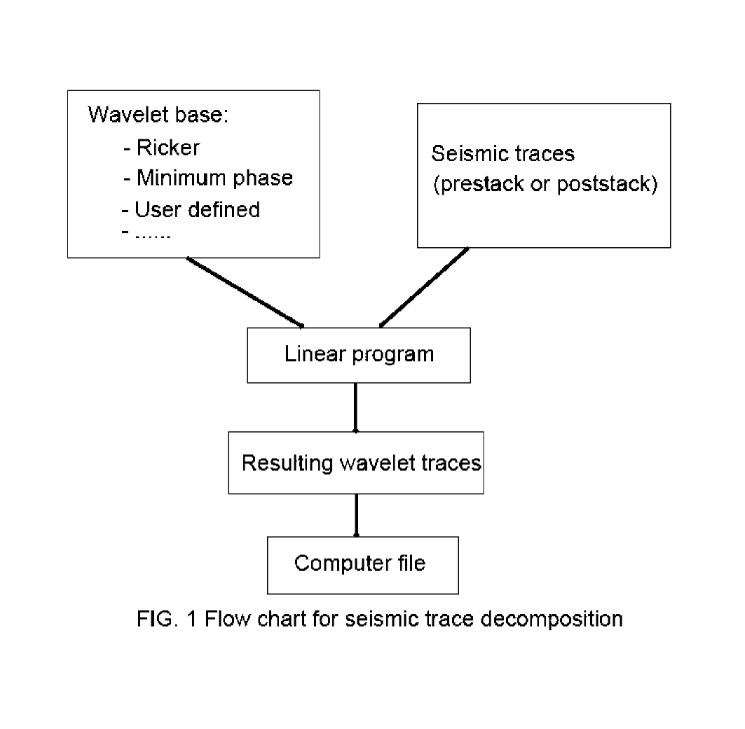

FIG. 1 shows the decomposition flow chart. A wavelet base should be first established. The wavelets can be divided into subsets by the type of the wavelets in the base. Types of the wavelets can include Ricker wavelets, minimum wavelets, maximum wavelets, user defined wavelets, and etc. The wavelets in the base are referenced by their type and dominant frequencies. A certain type or subset of the wavelets in the wavelet base may be used when decomposition is performed.

The interval of the dominant frequencies can be made smaller for higher accuracy of the decomposition and larger for fast decomposition computation. An interval of 1 Hz is normally used in this invention.

For easy description, a wavelet trace is defined as a data vector that has only one wavelet in the data vector and has the same number of amplitude samples as the seismic data trace to be decomposed.

With the wavelet base or a subset of the wavelets in the base, a linear program can be established as shown below for each seismic data trace to be decomposed.

Minimize: CX

Subject to: AX=B and X>=0

where X is the vector of variables to be solved for, C is the vector of weights for X, matrix A is of wavelet trace columns and B is the seismic trace vector to be decomposed.

For each wavelet in the wavelet base or in the selected subset of the wavelets, a wavelet trace or vector is formed for each of the amplitude samples of the seismic trace to be decomposed. The wavelets of the wavelet traces are positioned at the positions of the amplitude samples of the seismic trace to be decomposed. The wavelet traces form the columns of matrix A. The above wavelet traces are multiplied by −1 and also added into matrix A.

For more accurate decomposition, maximum and minimum positions of the seismic trace are computed. Wavelet traces are then generate for the positions and added to the matrix A.

The expression “CX” is called objective function. C is a vector of weights for the corresponding wavelet traces in matrix A. The same values of 1 can be used.

The above linear program can be solved by one of the many linear optimization methods. A good presentation and reference of the interior point method can be found in Ross, et al. (1997).

Once the linear program is solved, the elements of vector X represent the amplitudes of the wavelet traces in matrix A. The wavelet traces with amplitudes that are larger than a certain threshold are kept and information required to recover the wavelet traces is saved to a computer file. The other wavelet traces are discarded.

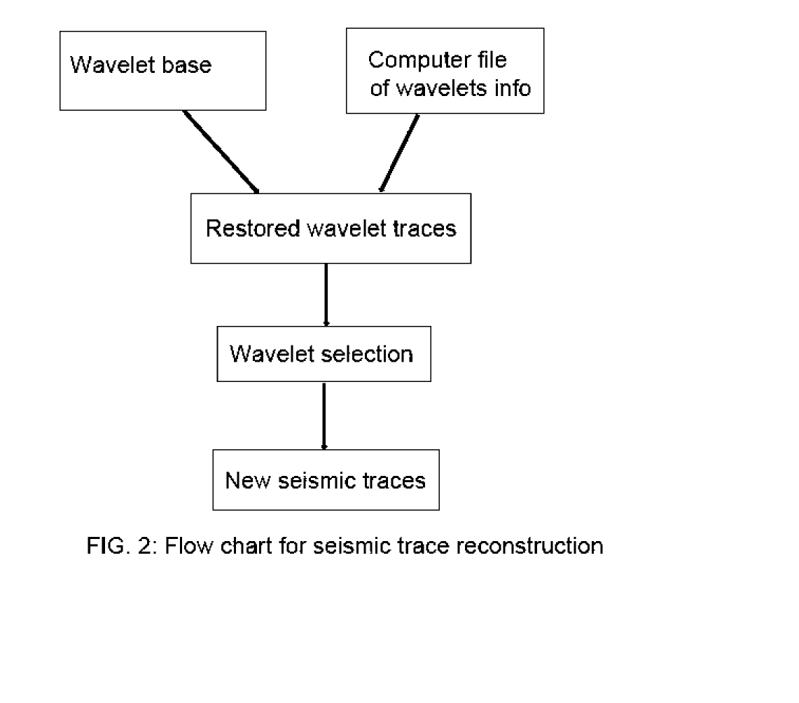

FIG. 2 shows the flow chart for seismic trace reconstruction from the saved wavelet information and the wavelet base. The wavelet trace information is retrieved from the computer file and the wavelets trace is recovered using the wavelet base. The wavelet traces can then be selected based on users request on position and dominant frequency. A new seismic trace is obtained by summing up the selected wavelet traces. The original seismic trace is obtained by summing up all the wavelet traces without selection.

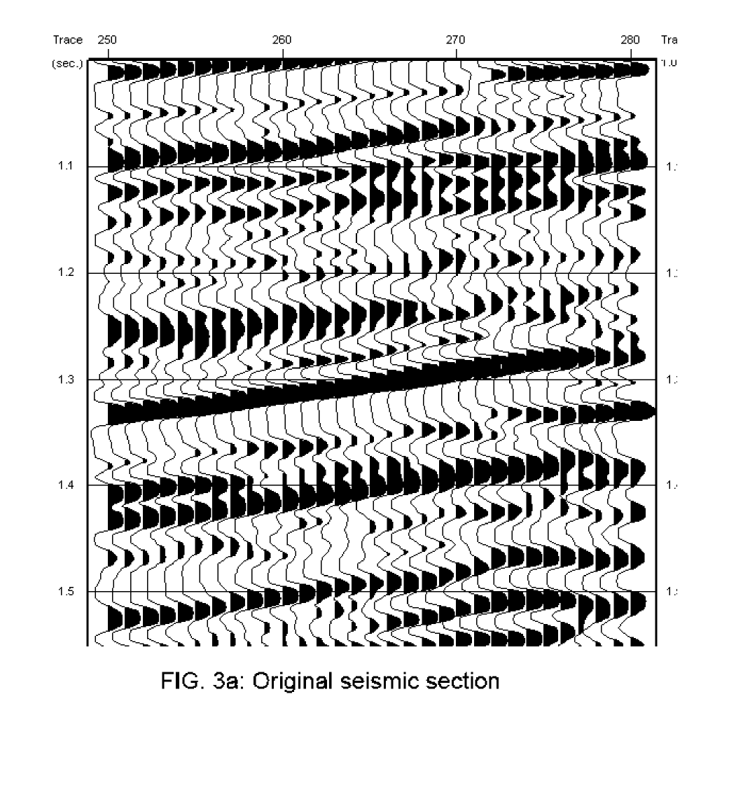

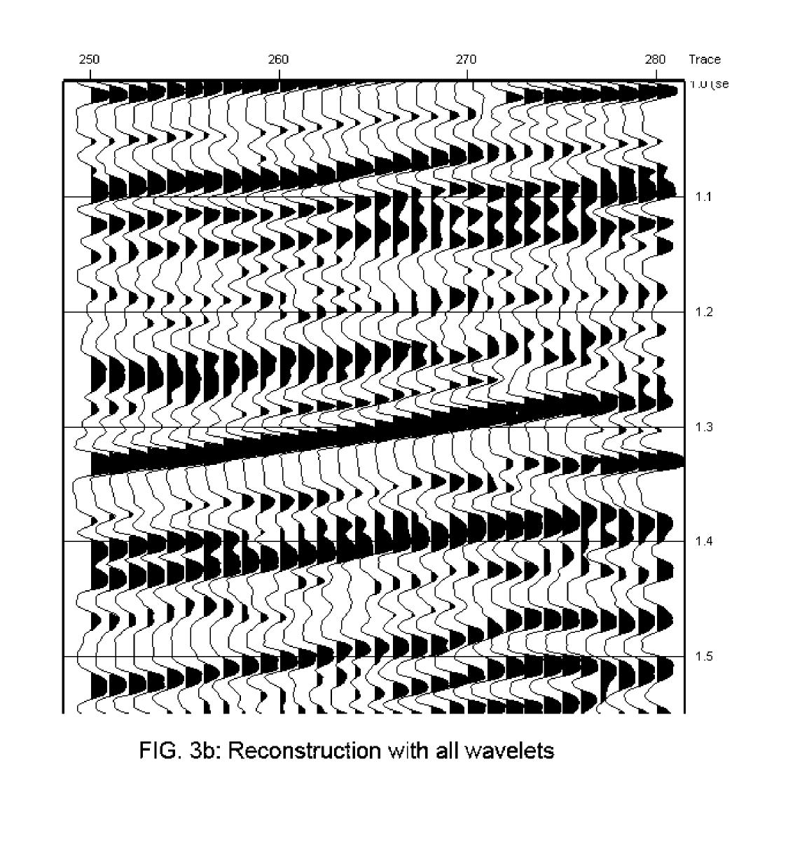

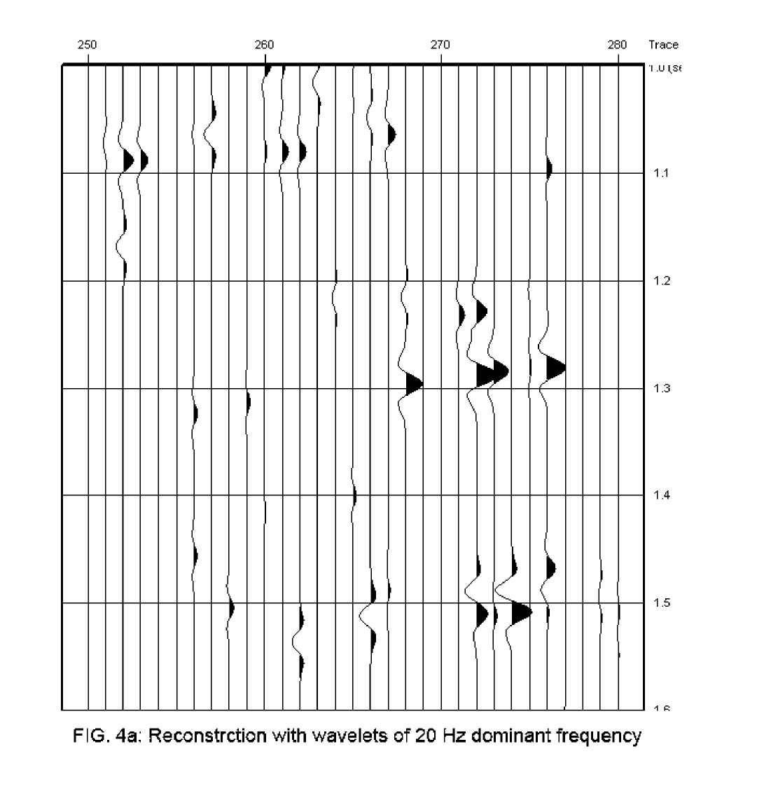

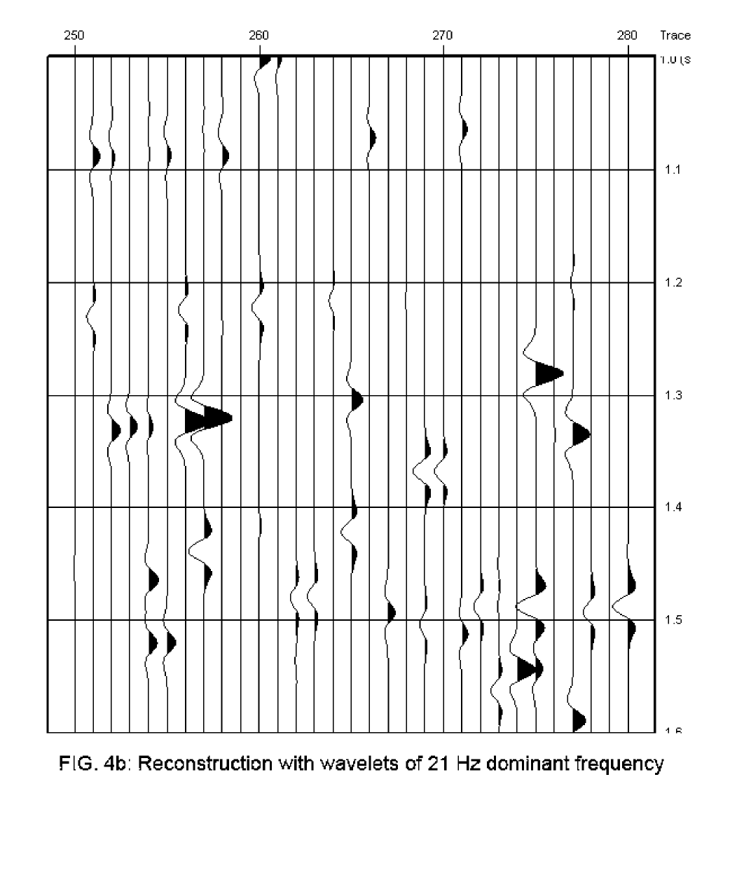

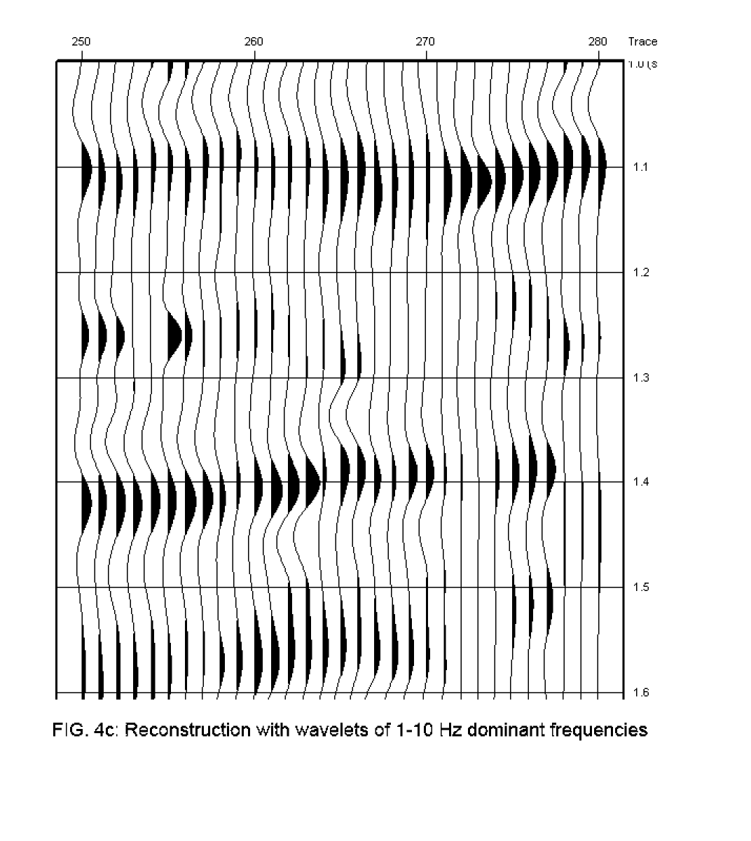

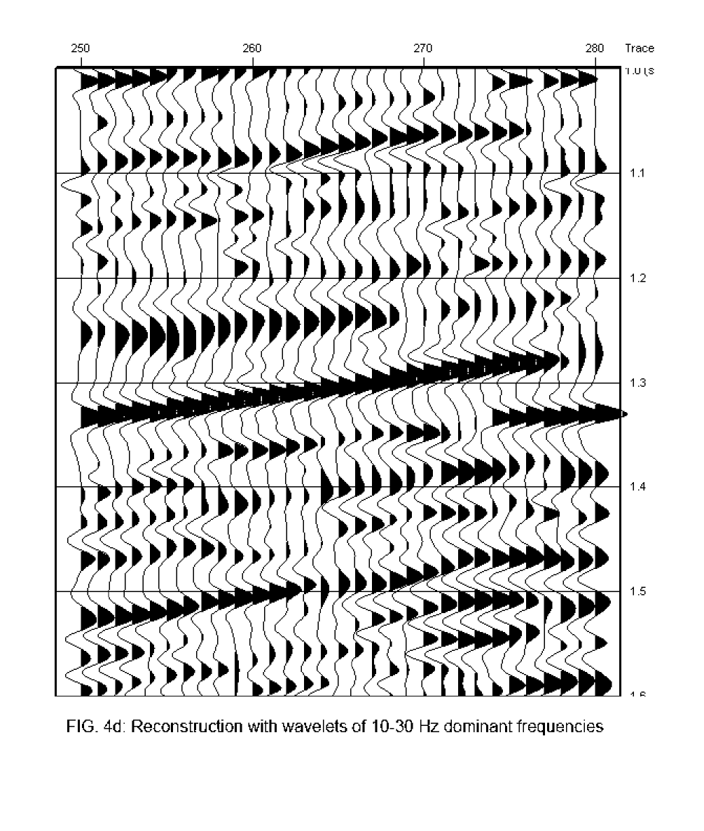

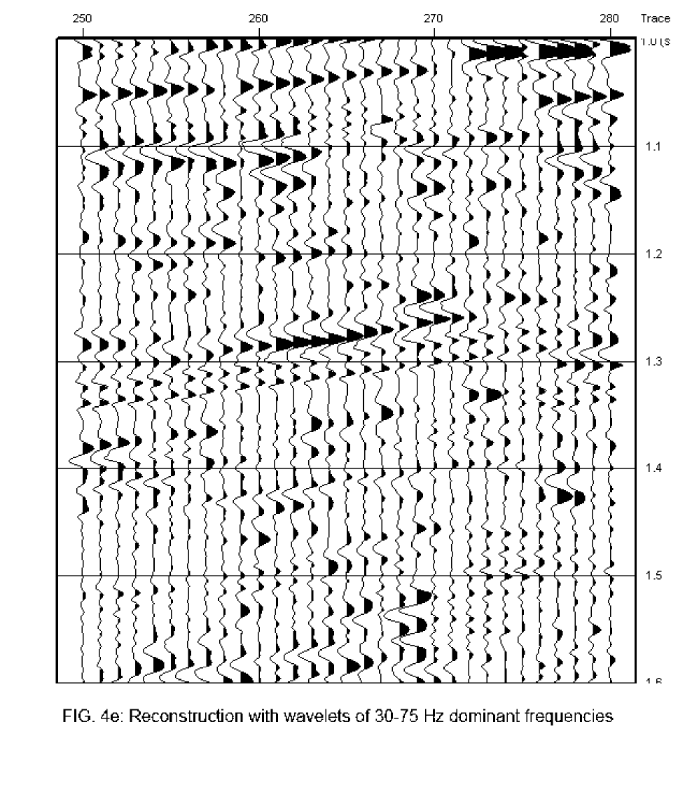

FIG. 3a and 3b show the original seismic section and the reconstruction of the original seismic section. FIG. 4a-4e show some examples of reconstructed new seismic sections of different dominant frequency range. All these examples used subset of Ricker wavelets.

REFERENCE:

Sheriff, R. E., 1999, Encyclopedic Dictionary of Exploration Geophysics, Third edition, Society of Exploration Geophysicists, p 52-53.

Ross, C., Terlaky, T. and Vial, J.-Ph, 1997, Theory and Algorithms for Linear Optimization, John Wiley & Sons.

FIGURE

What is claimed is:

1. A method for decomposition of seismic traces into a set of wavelets and reconstruction of the said seismic traces using the said set of wavelets and reconstruction of new seismic traces using a subset of the said set of the wavelets.

2. The method of claim 1 wherein the said method comprises method of seismic trace decomposition and method of original and new seismic traces reconstruction.

3. The said method of seismic trace decomposition of claim 2, wherein the said method of seismic trace decomposition comprises (a) establishment of a wavelet base; (b) establishment of a linear program based on the said wavelet base and the said seismic data trace; (c) computation of the optimal solution of the said linear program; and (d) store of the wavelets that provides the said optimal solution in a computer file.

4. The method of claim 3, wherein the said wavelet base comprises any wavelets of different shapes that are used in seismic data processing and interpretation. The said wavelets typically include, but not limited to following types such as Ricker wavelets, minimum phase wavelets and maximum phase wavelet.

5. The method of claim 4, wherein each of the said wavelets is named and referenced by its type and dominant frequencies of the said wavelets.

6. The method of claim 4, wherein the interval of the said dominant frequencies of the said wavelets in the said wavelet base is normally 1 Hz.

7. The method of claim 4, wherein the interval of the said dominant frequency of the said wavelets in the said wavelet base is made smaller to increase the accuracy of the said decomposition and made larger to achieve faster decomposition computation.

8. The method of claim 4, wherein the minimum dominant frequency of the said wavelets in the said wavelet base is determined by the minimum frequency content of the said actual seismic data trace.

9. The method of claim 4, wherein the maximum dominant frequency of the said wavelets in the said wavelet base is determined by the maximum frequency content of the said actual seismic data trace.

10. The method of claim 3, wherein the said establishment of a linear program comprises establishment of a matrix A by a subset of the said wavelet base and a vector B of the said seismic data trace and defining a vector C. The said linear program is then derived as:
minimize CX
subject to AX=B and X<=0
where X is the vector of variables to be solved for, CX is called the objective function.

11. The method of claim 10 wherein the said establishment of the said matrix A further comprises building wavelet columns using the said subset of wavelets in the said wavelet base. Suppose there are N amplitude samples in the said seismic data trace. For each wavelet in subset of the said wavelet base, N wavelet traces are built. Each wavelet trace corresponds to one amplitude sample of the said seismic data trace and has N amplitude samples and contains only one of the said wavelet whose position is corresponding to one of the N amplitude sample positions of the said seismic data trace. If there are M wavelets in the said subset of the said wavelet base, the number of wavelet trace columns is N multiplied by M or N*M.

12. The method of claim 11 wherein each of the said N*M wavelet columns is multiplied by −1 and then added to the said matrix A. The number of columns of matrix A becomes 2*N*M.

13. The method of claim 11 wherein the positions of the analytical maximums of the amplitude samples of the said seismic data trace are computed. These positions may not fall exactly on the positions of the amplitude samples of the said seismic data trace. For each maximum position of the said seismic trace, wavelet traces are generated for each wavelet in the said subset of the said wavelet base and the position of the wavelet of the generated wavelet traces are corresponding to the maximum positions of the said seismic trace. If the number of the maximum positions of the said seismic data trace is L, the number of columns of the said matrix A becomes 2*N*M+L*M.

14. The method of claim 11 wherein the positions of the analytical minimums of the amplitude samples of the said seismic data trace are computed. These positions may not fall exactly on the positions of the amplitude samples of the said seismic data trace. For each minimum position of the said seismic trace, wavelet traces are generated for each wavelet in said subset of the said wavelet base and the position of the wavelet of the generated wavelet traces are corresponding to the minimum positions of the said seismic trace. If the number of the minimum positions of the said seismic data trace is S, the number of columns of the said matrix A becomes 2*N*M+L*M+S*M.

15. The method of claim 10, wherein the said vector B of the said linear program is composed of the amplitude sample of the said seismic data trace.

16. The method of claim 10, wherein the said vector C is composed of weights of corresponding column of the said synthetic wavelet trace. The equal weight of 1 is used in the current invention.

17. The said computation of the optimal solution of the said linear program of claim 3 wherein comprises solving the linear program that is established by claim 10 through claim 16.

18. The method of claim 10 wherein the said vector X is solved and the elements of the said vector X are the amplitudes values of the corresponding wavelet trace columns.

19. The said store of the wavelets that provide the said optimal solution in a computer file of claim 3 further comprises elimination of some of the said wavelet traces that have amplitudes smaller than a threshold value and saving their amplitudes, positions and dominant frequencies of the remaining wavelet traces to a computer storage device, such as a hard disk drive.

20. The said method of original and new seismic traces reconstruction of claim 2, wherein comprises reconstruction of the original seismic traces and reconstruction of new seismic traces.

21. The said reconstruction of the original seismic traces of claim 20, wherein reconstruction of an original seismic trace of the said original seismic traces comprises three steps: (a) retrieving the saved amplitudes, positions, and dominant frequencies of the saved wavelets of the original seismic data trace from the said computer storage device of claim 19; (b) recovering the wavelet traces by using the said subset of the said wavelet base of claim 4 through claim 9; (c) adding all the wavelet traces. The resulting trace is an estimation of the said original seismic data trace.

22. The said reconstruction of new seismic traces of claim 20, wherein comprises three steps: (a) retrieving the saved amplitudes, positions, and dominant frequencies of the saved wavelets of the original seismic data trace from the said computer storage device of claim 19; (b) selecting the wavelet based on given wavelet positions and/or dominant frequencies to form a subset of wavelets; (c) recovering the wavelet traces by using the said subset of the said wavelet base of claim 4 through claim 9; (d) Adding the wavelet traces. The resulting trace is a new trace from the said original seismic data trace.

23. The method of claim 1 wherein the said seismic trace comprises seismic data traces before stack (known as pre-stack seismic traces) and seismic data traces after stack (known as post-stack seismic traces).
